(19) United States
(12) Patent Application Publication
(10) Pub. No.: US 2026/0187814 A1
(43) Pub. Date: Jul. 2, 2026

(54) IMAGE PROCESSING METHOD AND APPARATUS, DEVICE, AND MEDIUM

(71) Applicant: Beijing Zitiao Network Technology Co., Ltd., Beijing (CN)

(72) Inventors: Guangwei WANG, Beijing (CN); Jiawei Wen, Beijing (CN); Hengkai Guo, Beijing (CN)

(21) Appl. No.: 19/431,877

(22) Filed: Dec. 23, 2025

(30) Foreign Application Priority Data
Dec. 31, 2024 (CN) 202411998693.8

(51) Int. Cl. G06T 7/20; G06T 7/11; G06V 10/25; G06V 20/40

(52) U.S. Cl. CPC G06T 7/20; G06T 7/11; G06V 10/25; G06V 20/49

(57) ABSTRACT

The present disclosure provides an image processing method and apparatus, a device and a medium. The method includes: obtaining a first video frame image and a second video frame image to be processed in a first video; determining a first region in the first video frame image, and obtaining sparse optical flow information of the first region, based on the first video frame image and the second video frame image; performing grid division processing, based on the first region in the first video frame image, to obtain a plurality of grid vertices corresponding to the first region, and determining positions of the plurality of grid vertices corresponding to the first region in the second video frame image, based on the sparse optical flow information of the first region and the plurality of grid vertices corresponding to the first region.

### CROSS-REFERENCE TO RELATED APPLICATION(S)

This application claims priority to Chinese Application No. 202411998693.8 filed Dec. 31, 2024, the disclosure of which is incorporated herein by reference in its entirety.

### FIELD

The present disclosure relates to the technical field of computers, and more specifically, to an image processing method and apparatus, a device, and a medium.

### BACKGROUND

Tracking tasks can be applied to various scenarios such as first tracking, motion prediction, multimedia editing, and the like. Some tracking tasks are implemented depending on the optical flow estimation technology, which can work out the relationship between frame images using time-domain changes of pixels in an image sequence and a correlation between adjacent frames, to carry out the tracking tasks. In order to ensure the accuracy of the tracking task processing result, it is typically required to obtain dense optical flow information between the frame images.

### SUMMARY

In order to solve, or at least solve, the above-mentioned technical problem, the present disclosure provides an image processing method and apparatus, a device, and a medium.

Embodiments of the present disclosure provide an image processing method, comprising: obtaining a first video frame image and a second video frame image to be processed in a first video, wherein the first video frame image is a previous video frame image of the second video frame image; determining a first region in the first video frame image, and obtaining sparse optical flow information of the first region, based on the first video frame image and the second video frame image; performing grid division processing, based on the first region in the first video frame image, to obtain a plurality of grid vertices corresponding to the first region, and determining positions of the plurality of grid vertices corresponding to the first region in the second video frame image, based on the sparse optical flow information of the first region and the plurality of grid vertices corresponding to the first region; obtaining dense optical flow information of the first region, based on the positions of the plurality of grid vertices corresponding to the first region in the second video frame image; and performing a tracking task related to the first region, based on the dense optical flow information of the first region.

Optionally, obtaining the sparse optical flow information of the first region, based on the first video frame image and the second video frame image, comprises: downsampling the first video frame image to obtain a first downsampled image, and downsampling the second video frame image to obtain a second downsampled image; and obtaining displacement information of a first feature point in the first region, based on the first downsampled image and the second downsampled image, and obtaining the sparse optical flow information of the first region, based on the displacement information of the first feature point.

Optionally, the sparse optical flow information of the first region comprises displacement information of a first feature point in the first region; and determining positions of the plurality of grid vertices corresponding to the first region in the second video frame image, based on the sparse optical flow information of the first region and the plurality of grid vertices corresponding to the first region, comprises: determining a relative positional relationship between the first feature point and associated vertices among the plurality of grid vertices corresponding to the first region, based on a first feature point position of the first feature point in the first video frame image, and first vertex positions of the plurality of grid vertices corresponding to the first region in the first video frame image; obtaining a second feature point position of the first feature point in the second video frame image, based on the first feature point position corresponding to the first feature point and the displacement information; and determining positions of the plurality of grid vertices corresponding to the first region in the second video frame image, based on the relative positional relationship and the second feature point position of the first feature point.

Optionally, determining the positions of the plurality of grid vertices corresponding to the first region in the second video frame image, based on the relative positional relationship and the second feature point position of the first feature point, comprises: obtaining a preset grid constraint condition; and determining the positions of the plurality of grid vertices corresponding to the first region in the second video frame image, based on the relative positional position, the second feature point position of the first feature point, and the grid constraint condition.

Optionally, the grid constraint condition comprises one or more of the following: a first constraint condition related to a side length of a cell in a first grid, wherein the first grid is a total grid formed by the plurality of grid vertices corresponding to the first region and includes a plurality of cells each corresponding to four grid vertices; a second constraint condition related to an angle between adjacent sides of a cell in the first grid; or a third constraint condition related to an area scaling factor of the first grid, wherein the area scaling factor is a ratio of an area of the first grid in the second video frame image to an area of the first grid in the first video frame image.

Optionally, the first constraint condition is used to constrain variances respectively corresponding to four sides of the cell to be less than a preset variance threshold; the second constraint condition is used to constrain the angle between the adjacent sides of the cell to be within a preset angle range; and the third constraint condition is used to constrain the area scaling factor to be greater than a preset factor threshold.

Optionally, obtaining the dense optical flow information of the first region, based on the positions of the plurality of grid vertices corresponding to the first region in the second video frame image, comprises: obtaining displacement information of a pixel point in the first region, based on the positions of the plurality of grid vertices corresponding to the first region in the second video frame image and a preset polynomial spline interpolation algorithm; and obtaining the dense optical flow information of the first region, based on the displacement information of the pixel point in the first region.

Optionally, performing grid division processing, based on the first region in the first video frame image, to obtain the plurality of grid vertices corresponding to the first region, comprises: in the case that the first region is an irregular region, determining a minimum bounding rectangle of the first region in the first video frame image; performing grid division processing on the minimum bounding rectangle, to obtain a plurality of grid vertices corresponding to the minimum bounding rectangle; and extracting the plurality of grid vertices corresponding to the first region from the plurality of grid vertices corresponding to the minimum bounding rectangle.

The embodiments of the present disclosure further provide an image processing apparatus, comprising: a frame image obtaining module for obtaining a first video frame image and a second video frame image to be processed in a first video, wherein the first video frame image is a previous video frame image of the second video frame image; a sparse optical flow obtaining module for determining a first region in the first video frame image, and obtaining sparse optical flow information of the first region, based on the first video frame image and the second video frame image; a vertex position determining module for performing grid division processing, based on the first region in the first video frame image, to obtain a plurality of grid vertices corresponding to the first region, and determining positions of the plurality of grid vertices corresponding to the first region in the second video frame image, based on the sparse optical flow information of the first region and the plurality of grid vertices corresponding to the first region; a dense optical flow obtaining module for obtaining the dense optical flow information of the first region, based on the positions of the plurality of grid vertices corresponding to the first region in the second video frame image; and a tracking task performing module for performing a tracking task related to the first region, based on the dense optical flow information of the first region.

The embodiments of the present disclosure further provide an electronic device, comprising: a storage having a computer program stored thereon; and a processing apparatus for executing the computer program in the storage, to implement steps of the image processing method provided by the embodiments of the present disclosure.

The embodiment of the present disclosure further provides a computer-readable storage medium, wherein the storage medium stores a computer program, and the computer program is used to execute the image processing method provided by the embodiment of the present disclosure.

The embodiments of the present disclosure further provide a computer program product, wherein the storage medium stores thereon a computer program for performing the image processing method provided by the embodiments of the present disclosure.

The technical solution provided by the embodiments of the present disclosure can obtain sparse optical flow information of the first region, based on the first video frame image and the second video frame image; then perform grid division processing, based on the first region in the first video frame image, to obtain a plurality of grid vertices corresponding to the first region, and determining positions of the plurality of grid vertices corresponding to the first region in the second video frame image, based on the sparse optical flow information of the first region and the plurality of grid vertices corresponding to the first region; on the basis, obtain dense optical flow information of the first region; and further, perform a tracking task related to the first region. Instead of obtaining the dense optical flow directly based on each pixel point, the method described above includes obtaining the sparse optical flow information, then obtaining positions of a limited number of grid vertices on the basis, and further calculating the dense optical flow information in conjunction with the positions of the grid vertices.

It would be appreciated that the content described here is not intended to identify key features or essential features of the present disclosure, nor is it intended to be used to limit the scope of the present disclosure. Other features of the present disclosure will be made apparent through the following description.

### BRIEF DESCRIPTION OF THE DRAWINGS

The accompanying drawings, which are incorporated into the description and formulate a part thereof, show embodiments in line with the present disclosure and explain, together with the description, the principle of the present disclosure.

In order to make the technical solution clearer according to the embodiments of the present disclosure or the prior art, a brief introduction of the drawings required in the embodiments or the prior art will be provided below. Apparently, the ordinary skill in the art could derive other drawings on the basis of these drawings, without doing creative work.

FIG. 1 illustrates a flowchart of an image processing method provided by embodiments of the present disclosure;

FIG. 2 illustrates a schematic diagram of a grid provided by embodiments of the present disclosure;

FIG. 3 illustrates a schematic diagram of grid division processing for an irregular region provided by embodiments of the present disclosure;

FIG. 4 illustrates a schematic diagram of tracking processing provided by embodiments of the present disclosure;

FIG. 5 illustrates a schematic diagram of tracking processing provided by embodiments of the present disclosure;

FIG. 6 illustrates a schematic diagram of a structure of an image processing apparatus provided by embodiments of the present disclosure; and

FIG. 7 illustrates a schematic diagram of a structure of an electronic device provided by embodiments of the present disclosure.

### DETAILED DESCRIPTION OF EMBODIMENTS

In order to make the above objective, features, and advantages much clearer, a description of the solution according to the present disclosure will be further detailed below. It is worth noting that the embodiments of the present disclosure and the features therein could be combined with each other if no conflict is generated.

Although lots of details will be described below for a full understanding of the present disclosure, the present disclosure could be implemented in other ways than the one described herein. Obviously, the embodiments of the present disclosure are only a part of the embodiments of the present disclosure, not all of them.

The existing methods for obtaining dense optical flow information are generally time-consuming and inefficient, resulting in low tracking efficiency.

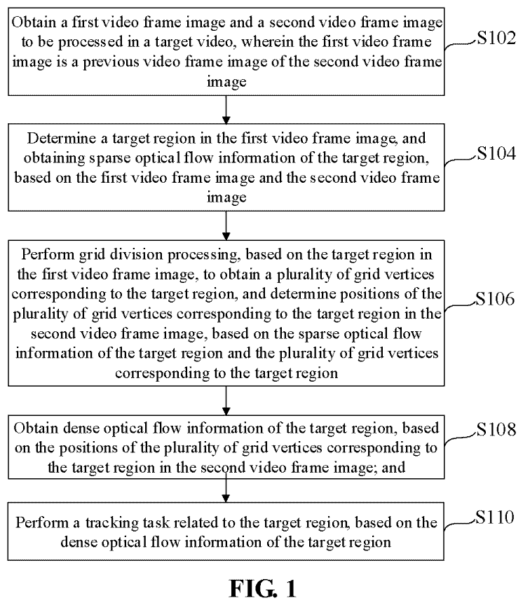

FIG. 1 illustrates a flowchart of an image processing method provided by embodiments of the present disclosure. The method can be performed by an image processing apparatus that can be implemented using software and/or hardware and is typically integrated in an electronic device. As shown therein, the method mainly includes steps S102 through S108 below:
S102: a first video frame image and a second video frame image to be processed in a first video are obtained, wherein the first video frame image is a previous video frame image of the second video frame image.

In the actual application, any frame image but the last one in the first video can be used as the first video frame image, and any frame image but the first one in the first video can be used as the second video frame image. The first video frame image and the second video frame image can be selected from the first video, as required, where the first video frame image is a previous video frame image of the second video frame image. For example, the first video frame image and the second video frame image are two frames of images adjacent to each other. For another example, a plurality of images can be extracted from the first video at preset frame number intervals, and the first video frame image and the second video frame image are two extracted frames of images with the above-mentioned preset frame number interval therebetween. In some specific implementations, two frames of images adjacent to each other are used as an example of the first video frame image and the second video frame image. Assumed that the first video is an image sequence composed of frame image 1 through frame image 200, the frame image 1 may be the first video frame image, and the frame image 2 may be the second video frame image. After being processed according to the image processing method provided by the embodiments of the present disclosure, the frame image 2 is used as the first video frame image, the frame image 3 is used as the second video frame image, and so on. Details are omitted herein for brevity.
Step 104: a first region in the first video frame image is determined, and sparse optical flow information of the first region is obtained based on the first video frame image and the second video frame image.

Any region having sparse optical flow information that needs to be obtained can be used as the first region. The first region may be a region to be tracked according to a tracking task. In some implementations, the first region can be specified flexibly according to needs. For example, in response to a region selection operation, a region corresponding to the region selection operation is used as the first region. In other words, the first region may be a specified region. In some other implementations, a region where a first object detected in the first video frame image is located may be the first region, where the first object may be the whole or a local part of a person, animal, or specific item, which can be flexibly set as required. All of the above are provided exemplarily, and the method for determining the first region can be set flexibly as required in the actual application, which is not limited herein. The sparse optical flow information of the first region may include motion information, such as displacement information of a plurality of first feature points of the first region. The first feature points can be set flexibly, which, for example, may be points meeting a specified condition, or may be points with salient features, or may be uniformly sampled points. Reference can be made to the related technology to obtain sparse optical flow information of the first region based on the first video frame image and the second video frame image. Alternatively, the related technology can be further improved. For example, downsampling is performed respectively for the first video frame image and the second video frame image, so as to further improve the speed of obtaining the sparse optical flow information while effectively reducing the computing amount.
S106: grid division processing is performed based on the first region in the first video frame image, to obtain a plurality of grid vertices corresponding to the first region, and positions of the plurality of grid vertices corresponding to the first region in the second video frame image is determined based on the sparse optical flow information of the first region and the plurality of grid vertices corresponding to the first region.

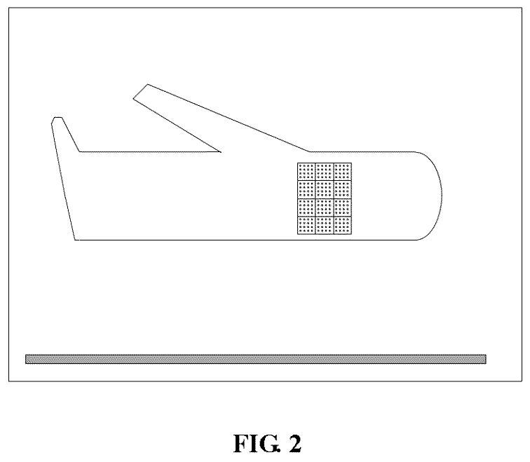

In the actual application, the grid division method can be set flexibly according to needs. The grid division method can be used to indicate one or more of a cell size, a number of grid division rows, a number of grid division columns, and the like. The grid division method may be preset or may be determined based on the size of the first region, i.e., it can be set flexibly. For ease of understanding, reference may be made to FIG. 2, which illustrates a schematic diagram of a grid. In FIG. 2, a rectangular region at the side of the aircraft in the video frame image is shown as a first region to be tracked, and the first region is uniformly divided into a plurality of square cells, where each cell has the same size and corresponds to four grid vertices, and a plurality of first features distributed uniformly are illustrated in each cell. It would be appreciated that FIG. 2 is only a simple example with a few cells shown therein, and the cell division method can be set flexibly in the actual application, according to the needs. According to the embodiments of the present disclosure, based on obtaining the sparse optical flow information of the first region (including displacement information of the first feature points) and the grid vertices and in conjunction with the relative positional relationship between the first feature points and the grid vertices, it is possible to reliably and efficiently determine positions of the plurality of grid vertices corresponding to the first region in the second video frame image. It would be appreciated that the number of grid vertices is much less than the number of first feature points. In this way, further sparse processing can be performed on the basis of the sparse optical flow information.
Step S108: dense optical flow information of the first region is obtained based on the positions of the plurality of grid vertices corresponding to the first region in the second video frame image.

The positions of the four grid vertices corresponding to each cell in the first region are known, i.e., the displacement information of the grid vertices between the first video frame image and the second video frame image is obtained. Based on the relative positional relationship between pixel points in the first region and grid vertices, displacement information of each pixel point in the first region between the first video frame image and the second video frame image can be obtained, thereby dense optical flow information of the first region is obtained.
Step S110: a tracking task related to the first region is performed based on the dense optical flow information of the first region. The tracking task is not limited herein in terms of the purpose, the application scenario, and the task performing method.

In a word, instead of obtaining the dense optical flow directly based on each pixel point, the method described above includes obtaining the sparse optical flow information, then obtaining positions of a limited number of grid vertices on the basis, and further inferring the dense optical flow information in conjunction with the positions of the grid vertices. Such a method for densifying a sparse optical flow is more efficient and requires less time, which can save more time cost and is helpful for further improving the tracking efficiency of the first region.

In some implementations, the step S104, namely obtaining sparse optical flow information of the first region based on the first video frame image and the second video frame image, can be implemented following steps 1 and 2 below:
Step 1: the first video frame image is downsampled to obtain a first downsampled image, and the second video frame image to is downsampled obtain a second downsampled image. The downsampling method is not specifically limited herein, which may include reducing image resolution, i.e., obtaining a first downsampled image and a second downsampled image of low resolution.
Step 2: displacement information of a first feature point in the first region is obtained based on the first downsampled image and the second downsampled image, and obtaining the sparse optical flow information of the first region, based on the displacement information of the first feature point. With the method of obtaining a sparse optical flow using an optical flow of low resolution, the calculation rate can be efficiently improved, but not all pixels of the first region can be covered at this time. Since there may be a certain error, the method is not suitable for performing the tracking task related to the first region directly based on this information. Therefore, on the basis, dense optical flow information of the first region will be obtained according to the embodiments of the present disclosure. Further description will be provided below.

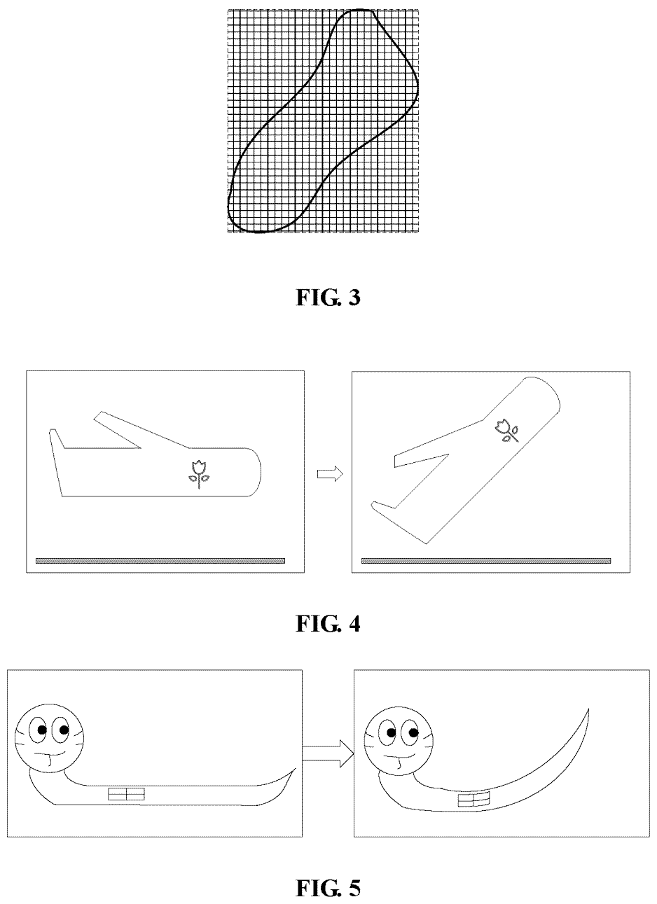

In some implementations, performing grid division processing, based on the first region in the first video frame image, to obtain a plurality of grid vertices corresponding to the first region, in step S106, can be implemented following steps (1) through (3) below:
(1) In the case that the first region is an irregular region, a minimum bounding rectangle of the first region in the first video frame image is determined.
(2) grid division processing on the minimum bounding rectangle is performed to obtain a plurality of grid vertices corresponding to the minimum bounding rectangle. For ease of understanding, reference will be made to FIG. 3 that illustrates a schematic diagram of grid division processing for an irregular region, where a region surrounded by the black line is an irregular first region. For conveniently performing grid division, a minimum bounding rectangle of the first region is determined; grid division processing is directly performed on the minimum bounding rectangle to obtain grid vertices corresponding to the minimum bounding rectangle.
(3) the plurality of grid vertices corresponding to the first region is extracted from the plurality of grid vertices corresponding to the minimum bounding rectangle. In some implementation examples, a plurality of grid vertices corresponding to the first region include all grid vertices within the first region. In addition, for ease of subsequent analysis and processing, the plurality of grid vertices corresponding to the first region further include all grid vertices corresponding to cells in which edge lines of the first region are located, i.e., even though a certain grid vertex is not located within the first region but the first region passes through a cell to which the grid vertex belongs, the grid vertex can still be regarded as a grid vertex corresponding to the first region. In other words, all the vertices corresponding to cells (located within the first region or having the edge line of the first region passing through) related to the first region can be considered as the plurality of grid vertices corresponding to the first region.

With the above method, grid division can be performed more conveniently and more efficiently for an irregular region, while grid vertices corresponding to the irregular region can be obtained, to further improve the processing efficiency.

As described above, the sparse optical flow information of the first region includes displacement information of first feature points in the first region. Determining positions of the plurality of grid vertices corresponding to the first region in the second video frame image, based on the sparse optical flow information of the first region and the plurality of grid vertices corresponding to the first region, in step S106, can be implemented specifically following steps a through c below:
Step a: a relative positional relationship between the first feature point and associated vertices among the plurality of grid vertices corresponding to the first region is determined based on a first feature point position of the first feature point in the first video frame image, and first vertex positions of the plurality of grid vertices corresponding to the first region.

The plurality of grid vertices corresponding to the first region form a total grid composed of a plurality of cells, where each cell has four grid vertices and includes therein a plurality of first feature points, and the associated vertices of the first feature point are four grid vertices corresponding to the cell to which the first feature point belongs. A certain first feature point in a certain cell is taken as an example. It is assumed that the coordinates of the four vertices of the cell are (x1, y1), (x2, y2), (x3, y3), and (x4, y4), and the coordinates of the first feature point are (X, Y). By way of example, the relative positional relationship between the first feature point and the associated vertices may be represented as follows: X=a1*x1+b1*x2+c1*x3+d1*x4, Y=a2*y1+b2*y2+c2*y3+d2*y4. That is, the coordinates of the first feature point can be represented using the coordinates of the four associated vertices. In the actual application, the bilinear interpolation can be used to determine the relative positional relationship between the first feature point and the associated vertices.
Step b: a second feature point position of the first feature point in the second video frame image is obtained based on the first feature point position corresponding to the first region and the displacement information. As the first feature point position of the first feature point in the first video frame image and the displacement information of the first feature point are known, the second feature point position of the first feature point in the second video frame image can be obtained, i.e., coordinates of the pixel of the first feature point in the second video frame image can be obtained.
Step c: positions of the plurality of grid vertices corresponding to the first region in the second video frame image are determined based on the relative positional relationship and the second feature point position of the first feature point. It would be appreciated that each cell in the total grid composed of a plurality of grid vertices includes first feature points. In this way, the positions of the grid vertices corresponding to each cell in the second video frame image can be obtained, i.e., the positions of all the grid vertices corresponding to the first region in the second video image can be obtained. In some specific implementation examples, the step c can be implemented following steps c1 and c2 below:
Step c1: a preset grid constraint condition is obtained. It would be appreciated that the grid vertices between the first video frame image and the second video frame image are displaced, i.e., the grid may be deformed. For example, the square cells in the first video frame image may be distorted in the second video frame image. In the embodiments of the present disclosure, a grid constraint condition is used to constrain the grid deformation level. Specifically, the grid constraint condition is used to restrict the grid deformation from being too large. By way of example, the grid constraint condition includes one or more of 1) through 3) below:
1) A first constraint condition related to a side length of a cell in a first grid, where the first grid is a total grid formed by the plurality of grid vertices corresponding to the first region and includes a plurality of cells each corresponding to four grid vertices. The first constraint condition is used to constrain variances corresponding to four sides of the cell to be less than a preset variance threshold. Specifically, for each cell, the respective distances between the four vertices are constrained such that the variances corresponding to the four sides of the cell can be less than the preset variance threshold. In this way, the lengths of the four sides of the cell can be effectively restricted from differing too much from one another, thus limiting the shape of the cell to a certain extent.
2) A second constraint condition related to an angle between adjacent sides of a cell in the first grid. The cell has four sides, and the angle between two adjacent sides among the four sides is an angle between adjacent sides of the cell. The second constraint condition is used to constrain the angle between adjacent sides of the cell to be within a preset angle range. For example, it can be guaranteed that the angles between adjacent sides of the cell are all positive, or less than 180 degrees, which can be set flexibly, and is not limited herein.
3) A third constraint condition related to an area scaling factor of the first grid, where the area scaling factor is a ratio of an area of the first grid in the second video frame image to an area of the first grid in the first video frame image. The third constraint condition is used to constrain the area scaling factor to be greater than a preset factor threshold. In the actual application, if the area scaling factor is less than the preset factor threshold, feedback information on a first region tracking failure will be returned.

In the actual application, one or more from 1) through 3 as described above could be selected for restriction according to the actual needs, which is not specifically limited herein. In this way, the present disclosure can accomplish the purpose of limiting the grid deformation to avoid too large grid deformation, and minimizing the grid deformation level between the first video frame image and the second video frame image.
Step c2: positions of the plurality of grid vertices corresponding to the first region in the second video frame image are determined based on the relative positional relationship, the second feature point position of the first feature point and the grid constraint condition.

It would be appreciated that the first grid includes a plurality of cells, each including a plurality of first feature points. The grid vertices corresponding to the cell are all constrained by the positions of the plurality of first feature points within the cell, i.e., each first feature point limits the associated grid vertices thereof. Therefore, there will be a system of equations formed by a plurality of sets of relative positional relationships. In the actual application, an optimal solution can be found for this system of equations, and the most suitable positions of the plurality of grid vertices corresponding to the first region in the second video frame image can be obtained. From another perspective, the inferred position of the first feature point can be obtained based on the positions of the plurality of grid vertices corresponding to the first region in the second video frame image and the relative positional relationship, and the difference between the inferred position and the actual position of the currently known first feature point in the second video frame image should be minimized.

In this way, the present disclosure can reasonably and reliably obtain displacements of grid vertices while effectively reducing the impact of the error of the sparse optical flow. Subsequently, displacements of pixel points in the first region can be further inferred with the aid of reliable position information of the grid vertices. In some implementations, step S108, namely the step of obtaining dense optical flow information of the first region, based on the positions of the plurality of grid vertices corresponding to the first region in the second video frame image, can be implemented following steps A and B below:
Step A: displacement information of a pixel point in the first region is obtained based on the positions of the plurality of grid vertices corresponding to the first region in the second video frame image, and a preset polynomial spline interpolation algorithm. The polynomial spline interpolation is a method for constructing a smooth curve or curved surface by interpolating piecewise polynomials between a set of given points, for example, a quadratic spline interpolation, a cubic spline interpolation, and the like, i.e., interpolation using polyharmonic spline transform is employed to determine a positions of the pixel point in the first region in the second video frame image, and displacement information of the pixel point in the first region is thus obtained. In this way, the obtained pixel point distribution is more accurate, and the overall presentation effect is smoother.
Step B: the dense optical flow information of the first region is obtained based on the displacement information of the pixel points in the first region. In the actual application, the pixel point may refer to each pixel point in the first region, and the displacement information of each pixel point in the first region may be used as dense optical flow information of the first region. As compared with the method of obtaining displacement information of a pixel point directly based on two frames of images according to the related technology, the above-mentioned method of obtaining displacement information of a pixel point based on information of grid vertices is more convenient and requires a smaller amount of computation and less time.

On the basis of obtaining the dense optical flow information of the first region, the tracking task related to the first region can be further performed. The tracking task related to the first region is not limited specifically herein. For example, by tracking the first region, special processing is performed on the first region. FIG. 4 illustrates a schematic diagram of tracking processing, where a flower pattern is attached to the tracked first region at the side of the aircraft. By tracking the first region, the effect that the flower moves with the first region can be implemented. For another example, the tracking task is a curved-surface tracking task. The curved-surface tracking task is mainly used for determining and following a three-dimensional surface of a first object in real time, where the three-dimensional surface of the first object may be the first region as described above. In the specific implementation, a virtual object (e.g. any object such as a specified identifier, a specified person, animal, item, or the like) can be placed in a first region of a frame of image in a first video; the position of the virtual object is specifically determined based on a position of a first feature point corresponding to the first region, and the first region is tracked continuously; the virtual object can continuously fit in a corresponding position based on the tracking information of the first region, where a curved-surface change may occur to the first region. For ease of understanding, reference will be made to FIG. 5 which illustrates a schematic diagram of tracking processing. A grid-like identifier pattern is attached to a tracked region of the snake's body. With the movement of the snake body, the tracked first region of the snake body will also change, for example, bending or the like. By tracking the first region, the identifier pattern can be consistently attached to the first region of the snake's body. In doing so, the effect that the shape of the identifier pattern can be changed with the shape of the first region, i.e., the curved-surface tracking effect, can be achieved.

In a word, the method provided by the embodiments of the present disclosure can include: obtaining sparse optical flow information of a tracked first region, performing sparsification on the basis to obtain positions of grid vertices between two frames of images, and further inferring and restoring displacement information of pixel points in the first region, i.e., obtaining dense optical flow information of the first region. Such a method of densifying a sparse optical flow is more efficient and requires less time, which can save more time cost and is helpful for efficiently and reliably performing a tracking task (e.g. a curved-surface task) related to the first region.

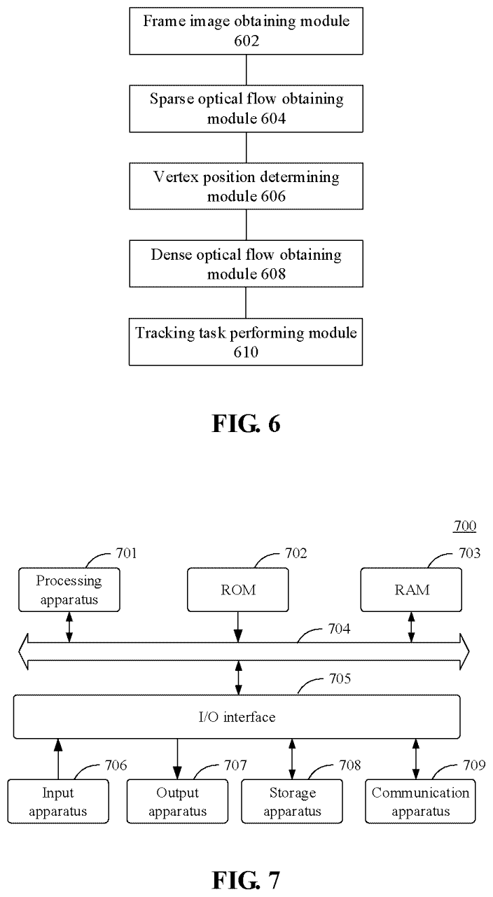

Corresponding to the image processing method described above, the embodiments of the present disclosure further provide an image processing apparatus. FIG. 6 illustrates a schematic diagram of a structure of an image processing apparatus provided by embodiments of the present disclosure, where the apparatus may be implemented by software and/or hardware and is typically integrated in an electronic device. As shown therein, the image processing apparatus includes:
a frame image obtaining module 602 for obtaining a first video frame image and a second video frame image to be processed in a first video, wherein the first video frame image is a previous video frame image of the second video frame image;
a sparse optical flow obtaining module 604 for determining a first region in the first video frame image, and obtaining sparse optical flow information of the first region, based on the first video frame image and the second video frame image;
a vertex position determining module 606 for performing grid division processing, based on the first region in the first video frame image, to obtain a plurality of grid vertices corresponding to the first region, and determining positions of the plurality of grid vertices corresponding to the first region in the second video frame image, based on the sparse optical flow information of the first region and the plurality of grid vertices corresponding to the first region;
a dense optical flow obtaining module 608 for obtaining the dense optical flow information of the first region, based on the positions of the plurality of grid vertices corresponding to the first region in the second video frame image; and
a tracking task performing module 610 for performing a tracking task related to the first region, based on the dense optical flow information of the first region.

Instead of obtaining the dense optical flow directly based on each pixel point, the apparatus described above is configured to obtain the sparse optical flow information, then obtain positions of a limited number of grid vertices on the basis, and further calculate the dense optical flow information in conjunction with the positions of the grid vertices. Such a method for densifying a sparse optical flow is more efficient and requires less time, which can save more time cost and is helpful for further improving the tracking efficiency of the first region.

In some implementations, the sparse optical flow obtaining module 604 is specifically used for: downsampling the first video frame image to obtain a first downsampled image, and downsampling the second video frame image to obtain a second downsampled image; and obtaining displacement information of a first feature point in the first region, based on the first downsampled image and the second downsampled image, and obtaining the sparse optical flow information of the first region, based on the displacement information of the first feature point.

In some implementations, the sparse optical flow information of the first region comprises displacement information of a first feature point in the first region; the vertex position determining module 606 is specifically used for: determining a relative positional relationship between the first feature point and associated vertices among the plurality of grid vertices corresponding to the first region, based on a first feature point position of the first feature point in the first video frame image, and first vertex positions of the plurality of grid vertices corresponding to the first region in the first video frame image; obtaining a second feature point position of the first feature point in the second video frame image, based on the first feature point position corresponding to the first feature point and the displacement information; and determining positions of the plurality of grid vertices corresponding to the first region in the second video frame image, based on the relative positional relationship and the second feature point position of the first feature point.

In some implementations, the vertex position determining module 606 is specifically used for: obtaining a preset grid constraint condition; and determining the positions of the plurality of grid vertices corresponding to the first region in the second video frame image, based on the relative positional position, the second feature point position of the first feature point, and the grid constraint condition.

In some implementations, the grid constraint condition comprises one or more of the following: a first constraint condition related to a side length of a cell in a first grid, wherein the first grid is a total grid formed by the plurality of grid vertices corresponding to the first region and includes a plurality of cells each corresponding to four grid vertices; a second constraint condition related to an angle between adjacent sides of a cell in the first grid; or a third constraint condition related to an area scaling factor of the first grid, wherein the area scaling factor is a ratio of an area of the first grid in the second video frame image to an area of the first grid in the first video frame image.

In some implementations, the first constraint condition is used to constrain variances respectively corresponding to four sides of the cell to be less than a preset variance threshold; the second constraint condition is used to constrain the angle between the adjacent sides of the cell to be within a preset angle range; and the third constraint condition is used to constrain the area scaling factor to be greater than a preset factor threshold.

In some implementations, the dense optical flow obtaining module 608 is specifically used for: obtaining displacement information of a pixel point in the first region, based on the positions of the plurality of grid vertices corresponding to the first region in the second video frame image and a preset polynomial spline interpolation algorithm; and obtaining the dense optical flow information of the first region, based on the displacement information of the pixel point in the first region.

In some implementations, the first region is a specified region; the vertex position determining module 606 is specifically used for: in the case that the first region is an irregular region, determining a minimum bounding rectangle of the first region in the first video frame image; performing grid division processing on the minimum bounding rectangle, to obtain a plurality of grid vertices corresponding to the minimum bounding rectangle; and extracting the plurality of grid vertices corresponding to the first region from the plurality of grid vertices corresponding to the minimum bounding rectangle.

The image processing apparatus provided by embodiments of the present disclosure can perform the image processing method provided by any of the embodiments of the present disclosure, which include functional modules corresponding to the method and can achieve the same advantageous effect.

Those skilled in the art could fully learn that, for convenience and brevity of description, reference may be made to the corresponding process according to the method embodiments for the specific working process of the apparatus embodiments. Details thereof are omitted herein for brevity.

The embodiments of the present disclosure provide an electronic device, including: a storage having a computer program stored thereon; and a processing apparatus for executing the computer program in the storage, to implement steps of the image processing method of any one of the embodiments of the present disclosure.

Hereinafter, reference will be made to FIG. 7 that illustrates a schematic diagram of an electronic device 700 adapted to implement embodiments of the present disclosure. The terminal device in the embodiments of the present disclosure may include, but is not limited to, a mobile terminal such as a mobile phone, a laptop computer, a digital broadcast receiver, a Personal Digital Assistant (PDA), a tablet computer (PAD), a Portable Multimedia Player (PMP), an on-vehicle terminal (e.g. an on-vehicle navigation terminal), or the like, or a fixed terminal such as a digital TV, a desktop computer, or the like. The electronic device as shown in FIG. 7 is only an example, without suggesting any limitation to the functions and the application range of the embodiments of the present disclosure.

As shown therein, the electronic device 700 may include a processing (e.g. a central processor, a graphics processor or the like) 701, which can perform various acts and processing based on programs stored in a Read-Only Memory (ROM) 702 or a program loaded from a storage 708 to a Random Access Memory (RAM) 703. RAM 703 stores therein various programs and data required for the operations of the electronic device 700. The processing apparatus 701, the ROM 702, and the RAM 703 are connected to one another via a bus 704. An input/output (I/O) interface 705 is also connected to the bus 704.

Typically, the following units may be connected to the I/O interface 705: an input apparatus 706 including, for example, a touchscreen, a touch pad, a keyboard, a mouse, a camera, a microphone, an accelerometer, a gyroscope, and the like; an output apparatus 707 including, for example, a Liquid Crystal Display (LCD), a loudspeaker, a vibrator, and the like; a storage 708 including, for example, a tape, a hard drive, and the like; and a communication apparatus 709. The communication apparatus 709 can allow wireless or wired communication of the electronic device 700 with other devices to exchange data. Although FIG. 7 shows the electronic device 700 including various units, it would be appreciated that not all of the units as shown are required to be implemented or provided. Alternatively, more or fewer units may be implemented or provided.

In particular, according to the embodiments of the present disclosure, the processes described above with reference to the flowcharts may be implemented as computer software programs. For example, embodiments of the present disclosure include a computer program product comprising computer programs carried on a computer-readable medium, where the computer programs containing program code are used for performing the methods as in the flowcharts. In those embodiments, the computer programs may be downloaded and installed from a network via the communication apparatus 709, or may be installed from the storage 708, or may be installed from the ROM 702. The computer programs, when executed by the processing apparatus 701, perform the above-described functions defined in the method according to the embodiments of the present disclosure.

In addition to the method and apparatus described above, the embodiments of the present disclosure further provide a computer program product comprising computer program instructions that, when executed by a processor, cause the processor to implement the method provided by the embodiments of the present disclosure. For the computer program product, computer program code for performing operations of the present disclosure may be written by using one or more program design language or any combination. The program design language includes object-oriented program design language, such as Java, Smalltalk, and C++, and further includes conventional process-type program design language, such as “C” or similar program design language. The program code may be completely or partially executed on a user computer, performed as an independent software packet, partially executed on the user computer and partially executed on a remote computer, or completely executed on the remote computer or a server.

Moreover, the embodiments of the present disclosure further provide a computer-readable storage medium, where the computer-readable storage medium stores therein computer-executable instructions that, when executed by a processor, implement the image processing method provided by the embodiments of the present disclosure.

The computer-readable medium may be a computer-readable signal medium or a computer-readable storage medium or any combination of the two. The readable medium may be, for example, but not limited to, an electronic, magnetic, optical, electromagnetic, infrared, or semiconductor system, apparatus, or device, or any combination of the foregoing. More specific examples (a non-exhaustive list) of the computer readable storage medium may include: an electrical connection having one or more wires, a portable computer diskette, a hard disk, a Random Access Memory (RAM), a Random-Only Memory (ROM), an Erasable Programmable Read-Only Memory (EPROM or flash memory), an optical fiber, a portable Compact Disc Read-Only Memory (CD-ROM), an optical storage, a magnetic storage device, or any suitable combination of the foregoing.

The embodiments of the present disclosure also provide a computer program product comprising a computer program/instruction that, when executed by a processor, implements the image processing method according to the embodiments of the present disclosure.

It would be appreciated that, prior to applying the technical solution, in accordance with the relevant laws and regulations, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

The relationship terms as used herein, for example, “first”, “second”, and the like, are only intended for distinguishing an entity or operation from a further entity or operation, but not necessarily require or imply that those entities or operations should have any of such actual relationships or orders. In addition, the terms “include”, “comprise”, or any other variant thereof are intended to cover a non-exclusive inclusion, such that a process, method, article, or device including a series of elements not only include those elements, but also cover other elements not listed explicitly, or further cover inherent elements of the process, method, article, or device. Unless specified otherwise, elements defined by the expression “including one...” do not exclude presence of additional identical elements in the process, method, article, or device including those elements.

The previous description of the disclosed embodiments is provided to enable those skilled in the art to implement or apply the present disclosure. Various modifications to these embodiments will be readily apparent to those skilled in the art, and the generic principles defined herein may be applied to other embodiments without departing from the spirit or scope of the present disclosure. Thus, the present disclosure is not intended to be limited to the embodiments shown herein but is to be accorded the widest scope consistent with the principles and novel features disclosed herein.

I/We claim:

1. An image processing method, comprising:
obtaining a first video frame image and a second video frame image to be processed in a first video, wherein the first video frame image is a previous video frame image of the second video frame image;
determining a first region in the first video frame image, and obtaining sparse optical flow information of the first region based on the first video frame image and the second video frame image;
performing grid division processing based on the first region in the first video frame image, to obtain a plurality of grid vertices corresponding to the first region, and determining positions of the plurality of grid vertices corresponding to the first region in the second video frame image based on the sparse optical flow information of the first region and the plurality of grid vertices corresponding to the first region;
obtaining dense optical flow information of the first region based on the positions of the plurality of grid vertices corresponding to the first region in the second video frame image; and
performing a tracking task related to the first region based on the dense optical flow information of the first region.

2. The method of claim 1, wherein obtaining the sparse optical flow information of the first region based on the first video frame image and the second video frame image, comprises:
downsampling the first video frame image to obtain a first downsampled image, and downsampling the second video frame image to obtain a second downsampled image; and
obtaining displacement information of a first feature point in the first region, based on the first downsampled image and the second downsampled image, and obtaining the sparse optical flow information of the first region, based on the displacement information of the first feature point.

3. The method of claim 1, wherein the sparse optical flow information of the first region comprises displacement information of a first feature point in the first region; and wherein determining positions of the plurality of grid vertices corresponding to the first region in the second video frame image based on the sparse optical flow information of the first region and the plurality of grid vertices corresponding to the first region, comprises:
determining a relative positional relationship between the first feature point and associated vertices among the plurality of grid vertices corresponding to the first region based on a first feature point position of the first feature point in the first video frame image, and first vertex positions of the plurality of grid vertices corresponding to the first region in the first video frame image;
obtaining a second feature point position of the first feature point in the second video frame image based on the first feature point position corresponding to the first feature point and the displacement information; and
determining positions of the plurality of grid vertices corresponding to the first region in the second video frame image based on the relative positional relationship and the second feature point position of the first feature point.

4. The method of claim 3, wherein determining the positions of the plurality of grid vertices corresponding to the first region in the second video frame image based on the relative positional relationship and the second feature point position of the first feature point, comprises:
obtaining a preset grid constraint condition; and
determining the positions of the plurality of grid vertices corresponding to the first region in the second video frame image based on the relative positional position, the second feature point position of the first feature point, and the grid constraint condition.

5. The method of claim 4, wherein the grid constraint condition comprises one or more of the following:
a first constraint condition related to a side length of a cell in a first grid, wherein the first grid is a total grid formed by the plurality of grid vertices corresponding to the first region and comprises a plurality of cells each corresponding to four grid vertices;
a second constraint condition related to an angle between adjacent sides of a cell in the first grid; or
a third constraint condition related to an area scaling factor of the first grid, wherein the area scaling factor is a ratio of an area of the first grid in the second video frame image to an area of the first grid in the first video frame image.

6. The method of claim 5, wherein:
the first constraint condition is used to constrain variances respectively corresponding to four sides of the cell to be less than a preset variance threshold;
the second constraint condition is used to constrain the angle between the adjacent sides of the cell to be within a preset angle range; and
the third constraint condition is used to constrain the area scaling factor to be greater than a preset factor threshold.

7. The method of claim 4, wherein obtaining the dense optical flow information of the first region based on the positions of the plurality of grid vertices corresponding to the first region in the second video frame image, comprises:
obtaining displacement information of a pixel point in the first region, based on the positions of the plurality of grid vertices corresponding to the first region in the second video frame image and a preset polynomial spline interpolation algorithm; and
obtaining the dense optical flow information of the first region based on the displacement information of the pixel point in the first region.

8. The method of claim 1, wherein performing grid division processing based on the first region in the first video frame image, to obtain the plurality of grid vertices corresponding to the first region, comprises:
in response to the first region being an irregular region, determining a minimum bounding rectangle of the first region in the first video frame image;
performing grid division processing on the minimum bounding rectangle to obtain a plurality of grid vertices corresponding to the minimum bounding rectangle; and
extracting the plurality of grid vertices corresponding to the first region from the plurality of grid vertices corresponding to the minimum bounding rectangle.

9. An electronic device, comprising:
a storage having instructions stored thereon; and
a possessor for executing the instructions in the storage, causing the device to:
obtain a first video frame image and a second video frame image to be processed in a first video, wherein the first video frame image is a previous video frame image of the second video frame image;
determine a first region in the first video frame image, and obtain sparse optical flow information of the first region based on the first video frame image and the second video frame image;
perform grid division processing based on the first region in the first video frame image, to obtain a plurality of grid vertices corresponding to the first region, and determine positions of the plurality of grid vertices corresponding to the first region in the second video frame image based on the sparse optical flow information of the first region and the plurality of grid vertices corresponding to the first region;
obtain dense optical flow information of the first region based on the positions of the plurality of grid vertices corresponding to the first region in the second video frame image; and
perform a tracking task related to the first region based on the dense optical flow information of the first region.

10. The device of claim 9, wherein the instructions causing the device to obtain the sparse optical flow information of the first region based on the first video frame image and the second video frame image, comprise the instructions causing the device to:
downsample the first video frame image to obtain a first downsampled image, and downsampling the second video frame image to obtain a second downsampled image; and
obtain displacement information of a first feature point in the first region, based on the first downsampled image and the second downsampled image, and obtaining the sparse optical flow information of the first region, based on the displacement information of the first feature point.

11. The device of claim 9, wherein the sparse optical flow information of the first region comprises displacement information of a first feature point in the first region; and wherein the instructions causing the device to determine positions of the plurality of grid vertices corresponding to the first region in the second video frame image based on the sparse optical flow information of the first region and the plurality of grid vertices corresponding to the first region, comprise instructions causing the device to:
determine a relative positional relationship between the first feature point and associated vertices among the plurality of grid vertices corresponding to the first region based on a first feature point position of the first feature point in the first video frame image, and first vertex positions of the plurality of grid vertices corresponding to the first region in the first video frame image;
obtain a second feature point position of the first feature point in the second video frame image based on the first feature point position corresponding to the first feature point and the displacement information; and
determine positions of the plurality of grid vertices corresponding to the first region in the second video frame image based on the relative positional relationship and the second feature point position of the first feature point.

12. The device of claim 11, wherein the instructions causing the device to determine the positions of the plurality of grid vertices corresponding to the first region in the second video frame image based on the relative positional relationship and the second feature point position of the first feature point comprise instructions causing the device to:
obtain a preset grid constraint condition; and
determine the positions of the plurality of grid vertices corresponding to the first region in the second video frame image based on the relative positional position, the second feature point position of the first feature point, and the grid constraint condition.

13. The device of claim 12, wherein the grid constraint condition comprises one or more of the following:
a first constraint condition related to a side length of a cell in a first grid, wherein the first grid is a total grid formed by the plurality of grid vertices corresponding to the first region and comprises a plurality of cells each corresponding to four grid vertices;
a second constraint condition related to an angle between adjacent sides of a cell in the first grid; or
a third constraint condition related to an area scaling factor of the first grid, wherein the area scaling factor is a ratio of an area of the first grid in the second video frame image to an area of the first grid in the first video frame image.

14. The device of claim 13, wherein:
the first constraint condition is used to constrain variances respectively corresponding to four sides of the cell to be less than a preset variance threshold;
the second constraint condition is used to constrain the angle between the adjacent sides of the cell to be within a preset angle range; and
the third constraint condition is used to constrain the area scaling factor to be greater than a preset factor threshold.

15. The device of claim 12, wherein the instructions causing the device to obtain the dense optical flow information of the first region based on the positions of the plurality of grid vertices corresponding to the first region in the second video frame image comprise instructions causing the device to:
obtain displacement information of a pixel point in the first region, based on the positions of the plurality of grid vertices corresponding to the first region in the second video frame image and a preset polynomial spline interpolation algorithm; and
obtain the dense optical flow information of the first region based on the displacement information of the pixel point in the first region.

16. The device of claim 9, wherein instructions causing the device to perform grid division processing based on the first region in the first video frame image, to obtain the plurality of grid vertices corresponding to the first region comprises instructions causing the device to:
in response to the first region being an irregular region, determine a minimum bounding rectangle of the first region in the first video frame image;
perform grid division processing on the minimum bounding rectangle to obtain a plurality of grid vertices corresponding to the minimum bounding rectangle; and
extract the plurality of grid vertices corresponding to the first region from the plurality of grid vertices corresponding to the minimum bounding rectangle.

17. A non-transitory computer-readable storage medium, wherein the storage medium stores thereon instructions, causing a device to:
obtain a first video frame image and a second video frame image to be processed in a first video, wherein the first video frame image is a previous video frame image of the second video frame image;
determine a first region in the first video frame image, and obtain sparse optical flow information of the first region based on the first video frame image and the second video frame image;
perform grid division processing based on the first region in the first video frame image, to obtain a plurality of grid vertices corresponding to the first region, and determine positions of the plurality of grid vertices corresponding to the first region in the second video frame image based on the sparse optical flow information of the first region and the plurality of grid vertices corresponding to the first region;
obtain dense optical flow information of the first region based on the positions of the plurality of grid vertices corresponding to the first region in the second video frame image; and
perform a tracking task related to the first region based on the dense optical flow information of the first region.

18. The medium of claim 17, wherein the instructions causing the device to obtain the sparse optical flow information of the first region based on the first video frame image and the second video frame image, comprise the instructions causing the device to:
downsample the first video frame image to obtain a first downsampled image, and downsampling the second video frame image to obtain a second downsampled image; and
obtain displacement information of a first feature point in the first region, based on the first downsampled image and the second downsampled image, and obtaining the sparse optical flow information of the first region, based on the displacement information of the first feature point.

19. The medium of claim 17, wherein the sparse optical flow information of the first region comprises displacement information of a first feature point in the first region; and wherein the instructions causing the device to determine positions of the plurality of grid vertices corresponding to the first region in the second video frame image based on the sparse optical flow information of the first region and the plurality of grid vertices corresponding to the first region, comprise instructions causing the device to:
determine a relative positional relationship between the first feature point and associated vertices among the plurality of grid vertices corresponding to the first region based on a first feature point position of the first feature point in the first video frame image, and first vertex positions of the plurality of grid vertices corresponding to the first region in the first video frame image;
obtain a second feature point position of the first feature point in the second video frame image based on the first feature point position corresponding to the first feature point and the displacement information; and
determine positions of the plurality of grid vertices corresponding to the first region in the second video frame image based on the relative positional relationship and the second feature point position of the first feature point.

20. The medium of claim 19, wherein the instructions causing the device to determine the positions of the plurality of grid vertices corresponding to the first region in the second video frame image based on the relative positional relationship and the second feature point position of the first feature point comprise instructions causing the device to:
obtain a preset grid constraint condition; and
determine the positions of the plurality of grid vertices corresponding to the first region in the second video frame image based on the relative positional position, the second feature point position of the first feature point, and the grid constraint condition.
